(19) United States
(12) Patent Application Publication
(10) Pub. No.: US 2012/0169097 A1
(43) Pub. Date: Jul. 5, 2012

(54) FRAME ASSEMBLY & CONNECTOR APPARATUS

(75) Inventor: Mark Mendes, Loganville, GA (US)

(73) Assignee: KIDS II, INC., Atlanta, GA (US)

(21) Appl. No.: 13/344,251

(22) Filed: Jan. 5, 2012

Related U.S. Application Data
(60) Provisional application No. 61/429,949, filed on Jan. 5, 2011.

(51) Int. Cl. A47D 1/10; B23P 11/00; A47D 15/00

(52) U.S. Cl. 297/250.1; 248/176.1; 29/525.01

(57) ABSTRACT

Various embodiments of the present invention are directed to a frame assembly configured for being collapsed or disassembled by a user, and later reassembled by the user for use in supporting one or more objects. According to various embodiments, the frame assembly includes a connector apparatus comprising one or more connector members configured for securing two or more of the frame assembly's frame members together in an assembled state. In particular, various embodiments of the connector apparatus are configured for safely maintaining the frame assembly in an assembled state, enabling convenient assembly of the frame assembly by a user, and preventing inadvertent or accidental disassembly of the frame assembly.

### CROSS-REFERENCE TO RELATED APPLICATIONS

This application claims priority from provisional U.S. Application No. 61/429,949 entitled “Frame Assembly & Connector Apparatus,” which was filed on Jan. 5, 2011, the entirety of which is herein incorporated by reference.

### BACKGROUND OF THE INVENTION

1. Field of the Invention

Various embodiments of the present invention described herein generally relate to a frame assembly, particularly a frame assembly with an improved connector apparatus.

2. Description of Related Art

Frame assemblies comprised of multiple frame components configured for being assembled together are frequently used for supporting various objects, such as children's seats. As an example, children's bouncer seats often include collapsible frame assemblies configured for being disassembled in order to permit easy storage and portability. Such collapsible frame assemblies are known to include a variety of connector devices for securing assembled frame components together.

For example, U.S. Pat. No. 6,616,237 discloses a child's bouncer seat that includes separate frame segments secured together by a frame connector. The frame connector comprises an elongated left connector having an upwardly protruding extension configured to be inserted into a right connector defining a channel with an upwardly open hole. When the left connector is properly aligned and inserted into the right connector, the extension will extend through the right connector's hole and secure the frame segments together.

As another example, certain children's bouncers known in the art include collapsible frames having separate frame segments secured together by securing clips rotatably connected to the frame segments. In particular, a pair of bouncer frame segments may be assembled by coupling the frame segments together and manually rotating the securing clips downwardly such that the clips engage an upper portion of the frame segments and prevent the frame segments from being decoupled.

However, there is a need in the art for a frame assembly that includes an improved connector apparatus for more conveniently securing separate frame members together in an assembled state. More particularly, there is a need for such an apparatus to be reliable, to be easy to use, to promote proper assembly of a frame, and to prevent inadvertent or accidental disassembly of the frame.

### BRIEF SUMMARY OF THE INVENTION

Various embodiments of the present invention are directed to a frame assembly configured for resting on a support surface and for supporting a child support device above the support surface. According to various embodiments, the frame assembly comprises a first frame member; a second frame member configured for being coupled to the first frame member; and a connector member operatively connected to the second frame member and configured for being moved relative to the second frame member between a disengaged orientation, in which the first and second frame members can be coupled together, and an engaged orientation, in which the connector member engages the first and second frame members in order to prevent the first and second frame members from being decoupled. In various embodiments, at least a portion of the connector member is positioned beneath the second frame member and the connector member is configured such that, when the first frame member and second frame member are coupled together and the frame assembly is positioned on a support surface, the connector member is positioned between the support surface and the first and second frame members and the weight of the frame assembly pushes the first and second frame members toward the engaged orientation with the connector member.

In addition, various embodiments of the present invention are directed to a child seating apparatus. In various embodiments, the child seating apparatus comprises a child support device; a frame assembly comprising an upper portion configured for suspending the child support device above a support surface, and a base portion configured for resting on the support surface and supporting the upper portion. The upper portion generally comprises one or more upper frame members extending upwardly from the frame assembly's base portion. The base portion generally comprises a first lower frame member; a second lower frame member configured for being coupled to the first lower frame member; and a connector member operatively connected to the second lower frame member and configured for being moved relative to the second lower frame member between a disengaged orientation, in which the first and second lower frame members can be coupled together, and an engaged orientation, in which the connector member engages the first and second lower frame members in order to prevent the first and second lower frame members from being decoupled. In various embodiments, at least a portion of the connector member is positioned beneath the second lower frame member, and the connector member is configured such that, when the first lower frame member and second lower frame member are coupled together and the frame assembly is positioned on a support surface, the connector member is positioned between the support surface and the first and second lower frame members and the weight of the child seating apparatus causes the first and second lower frame members to move into the engaged orientation with the connector member.

In addition, various embodiments of the present invention are directed to a method for assembling a frame assembly configured for supporting an object. In various embodiments, the method comprises the steps of: coupling a first frame member to a second frame member; placing the first frame member and the second frame member on a support surface such that a connector member positioned beneath the second frame member contacts the support surface; and moving the connector member from a disengaged orientation to an engaged orientation in which the connector member prevents the first frame member and second frame member from being decoupled.

### BRIEF DESCRIPTION OF THE SEVERAL VIEWS OF THE DRAWINGS

Reference will now be made to the accompanying drawings, which are not necessarily drawn to scale, and wherein:

FIG. 1 shows a perspective view of a frame assembly according to one embodiment of the present invention;

FIG. 2 shows a perspective view of a frame assembly and child support device according to one embodiment of the present invention;

FIG. 3 shows a perspective view of a frame member and connector member according to one embodiment of the present invention;

FIG. 4 shows a perspective view of a pair of frame members in a disassembled state and a connector member in a disengaged orientation according to one embodiment of the present invention;

FIG. 5 shows a perspective view of a pair of frame members coupled together and a connector member in a disengaged orientation according to one embodiment of the present invention;

FIG. 6 shows a perspective view of a pair of frame members coupled together and a connector member in an engaged orientation according to one embodiment of the present invention; and

FIG. 7 shows a bottom perspective view of a connector member according to one embodiment of the present invention.

### DETAILED DESCRIPTION OF THE INVENTION

The present invention will now be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

### Overview

Various embodiments of the present invention are directed to a frame assembly configured for being collapsed or disassembled by a user, and later reassembled by the user for use in supporting one or more objects. According to various embodiments, the frame assembly includes a connector apparatus comprising one or more connector members configured for securing two or more of the frame assembly's frame members together in an assembled state. In particular, various embodiments of the connector apparatus are configured for safely maintaining the frame assembly in an assembled state, enabling convenient assembly of the frame assembly by a user, and preventing inadvertent or accidental disassembly of the frame assembly.

### Collapsible Frame Assembly

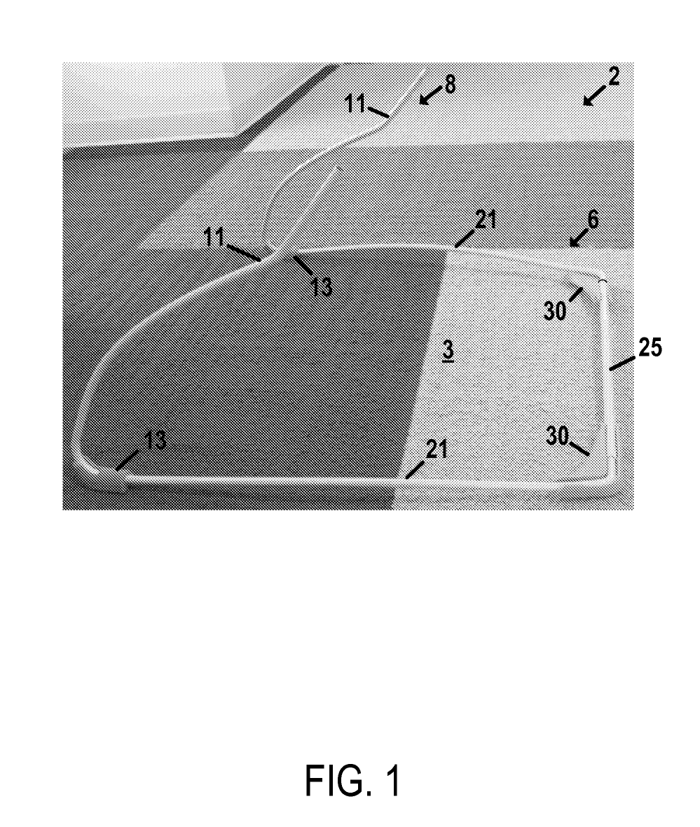

FIG. 1 illustrates a collapsible frame assembly 2 in an assembled state according to one embodiment. As shown in FIG. 1, the frame assembly 2 generally comprises a base portion 6 and an upper portion 8. In the frame assembly's assembled state, the upper portion 8 is generally configured for suspending a child support device (e.g., a children's seat) above a support surface, such as the floor 3 shown in FIG. 1. The base portion 6 is generally configured for resting on the support surface and providing a stable platform for supporting the upper portion 8. As described in greater detail below, the frame assembly 2 can be collapsed for storage or portability by disassembling various components of the frame assembly 2. Likewise, the frame assembly 2 can be conveniently reassembled in order to prepare the frame assembly 2 for use.

As shown in FIG. 1, the frame assembly's upper portion 8 includes a pair of upper frame members 11, and the frame assembly's base portion 6 includes a pair of lower frame members 21 and a cross member 25. In the illustrated embodiment of FIG. 1, the frame members 11, 21, and 25 are comprised of substantially elongated aluminum tubes. However, according to various embodiments, the frame members 11, 21, 25 may be comprised of materials having sufficient rigidity and strength for supporting a particular object (e.g., a child seat with a child seated therein). In addition, the cross-sectional shape and longitudinal profile of the various frame members 11, 21, 25 may be modified according to various embodiments.

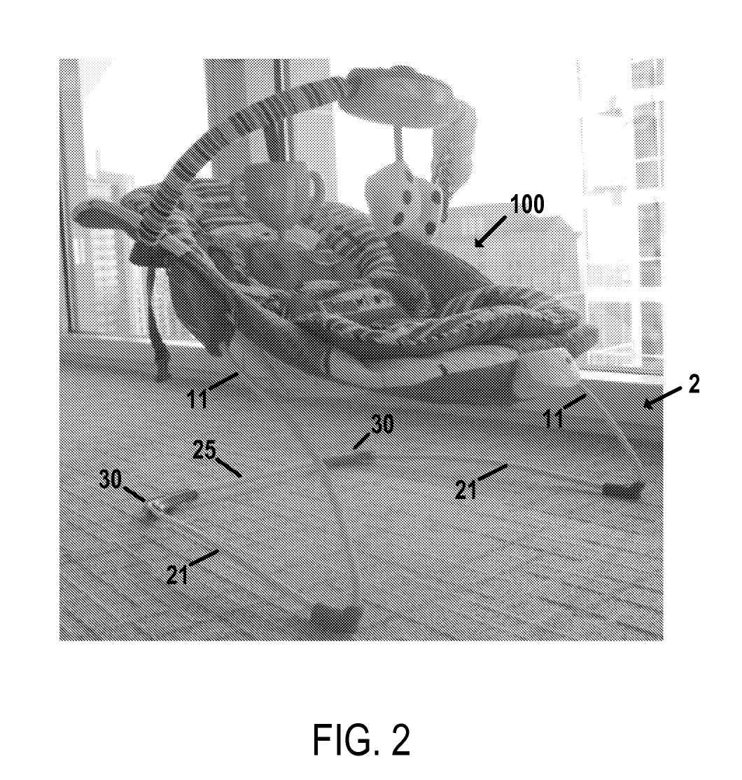

In the illustrated embodiment, the upper frame members 11 are positioned on lateral sides of the frame assembly 2 and extend generally upwardly from the frame assembly's base portion 6. In various embodiments, the upper ends of the upper frame members 11 are configured for attachment to a child support device in order to suspend the child support device above a support surface. For example, FIG. 2 illustrates one embodiment in which the frame assembly 2 supports a child support device 100 and is configured to function as a children's bouncer. As shown in FIG. 2, the base portion's frame members 21, 25 provide a platform for supporting the upper portion's upper frame members 11, which are operatively connected to the child support device 100.

Referring back to the illustrated embodiment of FIG. 1, the upper and lower frame members 11, 21 are comprised of a single, tubular frame member shaped to form both the upper and lower frame members 11, 21. However, according to various other embodiments, the upper and lower frame members 11, 21 may be separate frame members coupled together by any suitable method of attachment. In addition, in the illustrated embodiment of FIG. 1, the frame assembly 2 includes a pair of feet 13, which are operatively connected to the frame assembly 2 adjacent the intersection of the upper and lower frame members 11, 21. In various embodiments, the feet 13 may be comprised of a slip-resistant material, such as rubber, and are configured for providing a slip-resistant surface on which the frame assembly 2 can engage a support surface, such as the floor 3.

As noted above, the frame assembly's base portion 6 is generally configured for resting on a support surface and providing a stable base for the frame assembly's upper portion. Accordingly, in the illustrated embodiment of FIG. 1, the lower frame members 21 are positioned on lateral sides of the frame assembly 2 and are oriented generally horizontally and generally parallel to each another. The lower frame members 21 are spaced laterally apart from one another by the cross member 25, which is operatively connected to rearward ends of the lower frame members 21.

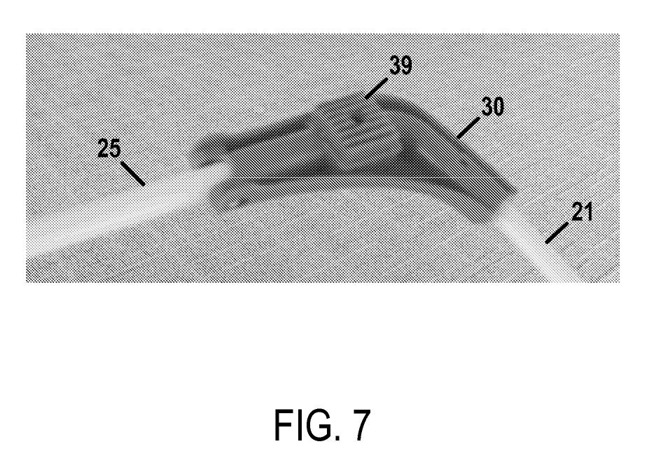

The cross member 25 includes a pair of connector members 30 positioned at opposite ends of the cross member 25. Each of the connector members 30 is configured for selectively securing one of the lower frame members 21 to the cross member 25. As described in greater detail below, the connector members 30 enable a user to conveniently and securely assemble the frame assembly 2. In addition, in the illustrated embodiment of FIG. 1, the connector members 30 include a slip-resistant surface on their lower ends. For example, as shown in the illustrated embodiment of FIG. 7, the connector member 30 includes a ribbed, rubber pad 39 positioned on its lower surface. Accordingly, when the connector members 30 are engaged and the frame assembly 2 is placed on a support surface, the pad 39 will grip the support surface and improve the stability of the frame assembly 2. Thus, in certain embodiments, the connector members 30 work in combination with the feet 13 to aid the frame assembly 2 in gripping a support surface. In various other embodiments, the frame members 21, 25 may be configured to rest directly on the floor 3.

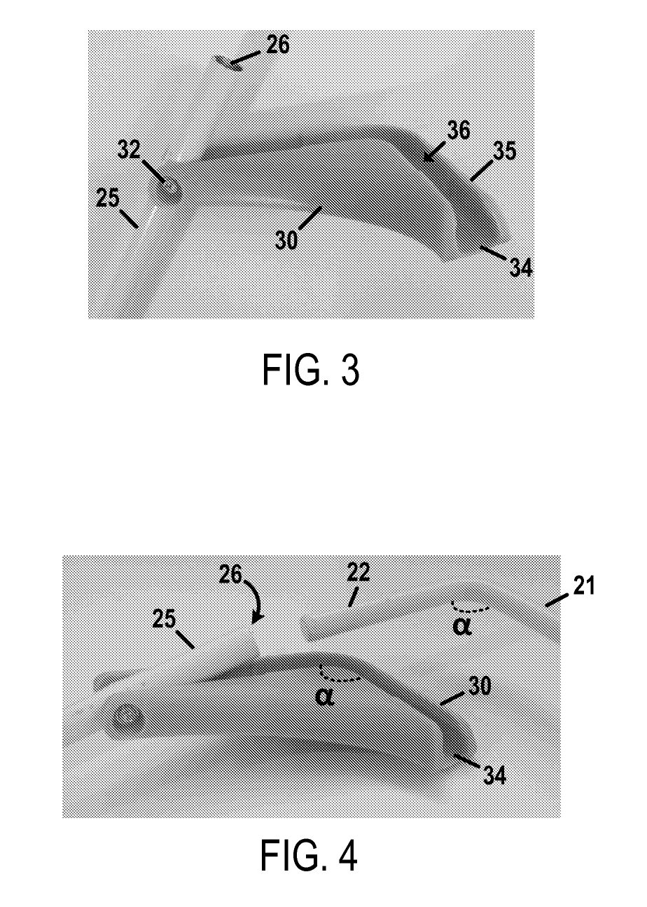

FIG. 3 shows a detailed view of one end of the cross member 25 and of one of the connector members 30. As shown in FIG. 3, the cross member's end defines a cavity 26. As described in more detail below, the cavity 26 is dimensioned for receiving a rearward end of one of the lower frame members 21. The connector member 30 is rotatably connected to the cross member 25 by a pin 32. In particular, the connector member 30 is positioned on the underside of the connector member 25, such that it can rotate between a downward, disengaged orientation (shown in FIGS. 3-5) and an upward, engaged orientation (shown in FIG. 6). In the illustrated embodiment, the connector member 30 is comprised of a generally L-shaped, resilient plastic member configured for receiving a portion of one of the lower frame members 21 and a portion of the cross member 25. However, according to various other embodiments, the connector member 30 may be comprised of any material of suitable rigidity and strength for securing the cross member 25 and lower frame member 21 together.

As shown in FIG. 3, the connector member 30 defines a central channel 34 having an upper opening 36 defined between the channel's upper edges 35. As the connector member 30 is generally configured to clip on to a portion of the cross member 25 and a portion of one of the lower frame members 21, the channel's upper edges 35 are configured to flex outwardly as the frame members 21, 25 are inserted through the channel's upper opening 36 and reflex inwardly once the frame members 21, 25 are fully inserted into the channel 34. When the frame members 21, 25 are fully inserted into the channel 34, the channel's upper edges extend partially over the upper portion of the frame members 21, 25 in order to secure the frame members 21, 25 within the channel 34. As described in greater detail below, once the frame members 21, 25 are fully inserted into the channel 34, a user may purposefully move the connector member 30 in order to disengage it from the frame members 21, 25.

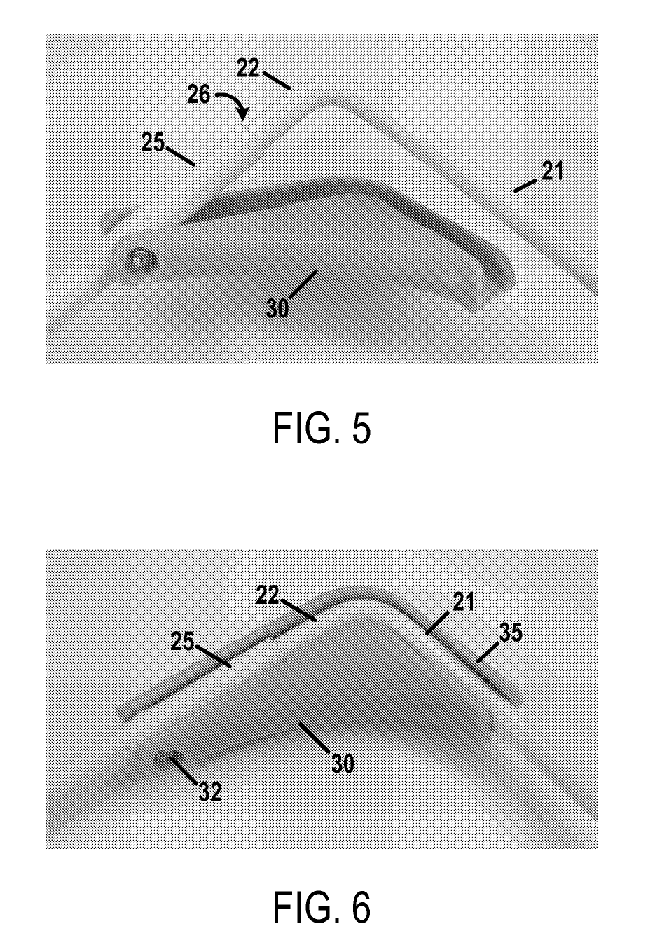

FIGS. 4 through 6 illustrate various steps for assembling the cross member 25 to one of the lower frame members 21. Generally, the cross member 25 and lower frame member 21 can be assembled together by first coupling an end of the cross member 25 to an end of the lower frame member 21, and then engaging the connector member 30 in order to secure the cross member 25 and lower frame member 21 together. As shown in FIG. 4, the lower frame member's rearward end includes an inwardly angled portion 22, which extends inwardly at an angle a from the elongated body portion of the lower frame member 21. Likewise, the connector member's channel 34 defines a substantially equivalent angle a in order to accommodate the lower frame member's angled portion 22. Accordingly, to couple the cross member 25 to the lower frame member 21, a user may first move the lower frame member's angled portion 22 proximate the cross member's cavity 26, as shown in FIG. 4. Next, as shown in FIG. 5, the user may insert the angled portion 22 of the lower frame member 21 into the cross member's cavity 26, thereby coupling the cross member 25 to the lower frame member 21. In other embodiments, the cross member 25 and lower frame member 21 may be coupled together using other methods (e.g., by using an intermediate fastening device).

Next, the user may position the cross member 25 and lower frame member 21 on a support surface (e.g., the floor 3) with the cross member 25 remaining coupled to the lower frame member 21, and the connector member 30 positioned between the support surface and the frame members 21, 25. As the user places the cross member 25 and lower frame member 21 on the support surface, the connector member 30 will engage the support surface and the frame members 21, 25 can be inserted into the connector member's channel 34 such that the connector member 30 moves from its downward, disengaged orientation to the upward, engaged orientation. For example, FIG. 6 shows the connector member 30 fully engaged with the frame members 21, 25. To complete assembly of the frame assembly 2, a similar process may be repeated (or conducted simultaneously) with the opposite lower frame member 21 and connector member 30 in order to secure the cross member 25 to both lower frame members 21. For embodiments in which the lower frame members 21 and upper frame members 22 are formed from a single frame member, or in which the frame members 21, 22 are not disassembled from one another, the frame assembly 2 may be fully assembled using only the steps of FIGS. 4-6.

According to various embodiments, the step of engaging the connector member 30 may be accomplished in a variety of ways depending on the configuration of the connector member 30. For example, in one embodiment, the connector member 30 may be configured such that a mild, downward force applied by a user on the coupled frame members 21, 25 will cause the connector member 30 to fully engage the frame members 21, 25. In such embodiments, a user may couple both lower frame members 21 to either side of the cross member 25, place the frame assembly 2 on a support surface, and apply a downward force on the frame assembly 2 that causes the frame members 21, 25 to engage the connector member 30. Alternatively, a user may deliberately insert the coupled frame members 21, 25 into the connector member's channel 34 by manually pushing the connector member 30 upward toward the frame members 21, 25.

In another embodiment, the connector member 30 may be configured such that the weight of the frame assembly 2 alone will cause the connector member 30 to fully engage the frame members 21, 25 when they are placed on a support surface. In such embodiments, simply coupling both lower frame members 21 to the cross member 25 and placing the frame assembly 2 on a support surface will cause the connector members 30 to fully engage. As a result, the connector members 30 can be configured to enable a passive method of assembling the frame assembly 2, which does not require the user to deliberately engage each of the connector members 30. Similarly, in various other embodiments, the connector member 30 may be configured such that the weight of the cross member 25 and lower frame member 21 alone, the weight of the frame assembly 2 and a child support device 100 alone, or the weight of the frame assembly 2, the child support device 100, and an infant of average weight alone will cause the connector member 30 to fully engage the frame members 21, 25 when they are placed on a support surface.

As will be appreciated from FIG. 6, the lower frame member 21 and connector member 25 cannot be decoupled from one another with the connector member 30 fully engaged. Accordingly, in order to disassemble the frame assembly 2, a user may deliberately disengage the connector member 30 and move it to its disengaged orientation. As this cannot be done with the connector member 30 sandwiched between a support surface and the frame members 21, 25, the positioning of at least a portion of the connector member 30 on the underside of the frame members 21, 25 causes the frame assembly 2 to remain safely assembled when in use. In various embodiments, with the connector members 30 engaged and the frame assembly 2 positioned on a support surface, the weight of the frame assembly 2 keeps the connector members 30 engaged and the frame members 21, 25 properly connected. This configuration helps to prevent inadvertent or accidental disassembly of the frame assembly 2.

As will be appreciated from the description provided herein, various modifications to the frame assembly 2 may be made within the scope of the present invention. For example, in certain embodiments, the connector members 30 may be rotatably connected to the lower frame members 21 as opposed to the cross member 25. In addition, the connector members 30 may take on a variety of shapes and configurations in order to accommodate various frame member shapes and profiles. In addition, the connector members 30 may be configured to move between the disengaged orientation and the engaged orientation in variety of ways. For example, the connector members 30 may be configured to for substantially vertical or lateral movement between their disengaged and engaged orientations. Furthermore, the connector members 30 may be adapted for use in connecting a variety of frame members comprising frame assemblies configured in various shapes and for various purposes, including rockers, swing frames, high chairs, folding chairs, easels, and display boards.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A frame assembly configured for resting on a support surface and for supporting a child support device above the support surface, the frame assembly comprising:
a first frame member;
a second frame member configured for being coupled to the first frame member; and
a connector member operatively connected to the second frame member and configured for being moved relative to the second frame member between a disengaged orientation, in which the first and second frame members can be coupled together, and an engaged orientation, in which the connector member engages the first and second frame members in order to prevent the first and second frame members from being decoupled;
wherein at least a portion of the connector member is positioned beneath the second frame member, and wherein the connector member is configured such that, when the first frame member and second frame member are coupled together and the frame assembly is positioned on a support surface, the connector member is positioned between the support surface and the first and second frame members and the weight of the frame assembly pushes the first and second frame members toward the engaged orientation with the connector member.

2. The frame assembly of claim 1, wherein the connector member is further configured such that, when the first frame member and second frame member are coupled together and positioned on a support surface, the weight of the frame assembly causes the first and second frame members to move into the engaged orientation with the connector member.

3. The frame assembly of claim 1, wherein the connector member defines an upwardly open channel configured for receiving at least a portion of the first and second frame members when the connector member is in the engaged orientation.

4. The frame assembly of claim 3, wherein the connector member is configured to clip on to the first and second frame members when the connector member is in the engaged orientation.

5. The frame assembly of claim 3, wherein first frame member includes an angled portion defining at least one angle of less than 180 degrees.

6. The frame assembly of claim 5, wherein the first frame member is substantially L-shaped.

7. The frame assembly of claim 5, wherein the connector member's upwardly open channel defines an angle substantially equal to the at least one angle defined by the first frame member.

8. The frame assembly of claim 3, wherein the connector member is rotatably connected to the second frame member and is configured to rotate relative to the second frame member between the disengaged orientation and the engaged orientation.

9. The frame assembly of claim 1, wherein an end of the second frame member defines a cavity and an end of the first frame member is configured for being inserted into the cavity of the second frame member in order to couple the first frame member and second frame member together.

10. The frame assembly of claim 1, wherein an end of the first frame member defines a cavity and an end of the second frame member is configured for being inserted into the cavity of the first frame member in order to couple the first frame member and second frame member together.

11. The frame assembly of claim 1, wherein the first frame member and second frame member are coupled together by an intermediate member positioned between the first frame member and the second frame member.

12. The frame assembly of claim 1, wherein the connector member comprises a first connector member, and wherein the frame assembly further comprises:
a third frame member for being coupled to the second frame member; and
a second connector member operatively connected to the second frame member and configured for being moved relative to the second frame member between a disengaged orientation, in which the second and third frame members can be coupled together, and an engaged orientation, in which the second connector member engages the second and third frame members in order to prevent the second and third frame members from being decoupled;
wherein the second connector member is configured such that at least a portion of the second connector member is positioned beneath the second frame member and, when the second frame member and third frame member are coupled together and the frame assembly is positioned on a support surface, the second connector member is positioned between the support surface and the second and third frame members and the weight of the frame assembly pushes the second and third frame members toward the engaged orientation with the second connector member.

13. The frame assembly of claim 12, wherein the first frame member is configured for being coupled to a first end of the second frame member, and the third frame member is configured for being coupled to a second end of the second frame member, such that, when the second frame member is coupled to the first frame member and the third frame member, the first frame member is spaced laterally apart from the third frame member.

14. The frame assembly of claim 1, wherein the connector member further comprises a slip-resistant bottom surface configured to engage the support surface.

15. The frame assembly of claim 14, wherein the slip-resistant bottom surface comprises a ribbed, rubber surface.

16. A child seating apparatus comprising:
a child support device; and
a frame assembly comprising an upper portion configured for suspending the child support device above a support surface, and a base portion configured for resting on the support surface and supporting the upper portion, wherein:
the upper portion comprises one or more upper frame members, the upper frame members extending upwardly from the frame assembly's base portion; and
the base portion comprises:
a first lower frame member;
a second lower frame member configured for being coupled to the first lower frame member; and
a connector member operatively connected to the second lower frame member and configured for being moved relative to the second lower frame member between a disengaged orientation, in which the first and second lower frame members can be coupled together, and an engaged orientation, in which the connector member engages the first and second lower frame members in order to prevent the first and second lower frame members from being decoupled;
wherein at least a portion of the connector member is positioned beneath the second lower frame member, and wherein the connector member is configured such that, when the first lower frame member and second lower frame member are coupled together and the frame assembly is positioned on a support surface, the connector member is positioned between the support surface and the first and second lower frame members and the weight of the child seating apparatus causes the first and second lower frame members to move toward the engaged orientation with the connector member.

17. The child seating apparatus of claim 16, wherein the connector member is further configured such that, when the first lower frame member and second lower frame member are coupled together and the frame assembly is positioned on a support surface, the weight of the child seating apparatus causes the first and second lower frame members to move into the engaged orientation with the connector member.

18. The child seating apparatus of claim 16, wherein the connector member is rotatably connected to the second lower frame member and is configured to rotate relative to the second lower frame member between the disengaged orientation and the engaged orientation.

19. The child seating apparatus of claim 16, wherein the connector member further comprises a slip-resistant bottom surface configured to engage the support surface.

20. A method for assembling a frame assembly configured for supporting an object, the method comprising the steps of:
coupling a first frame member to a second frame member;
placing the first frame member and the second frame member on a support surface such that a connector member positioned beneath the second frame member contacts the support surface; and
moving the connector member from a disengaged orientation to an engaged orientation in which the connector member prevents the first frame member and second frame member from being decoupled.

21. The method of claim 20, wherein the step of moving the connector member from a disengaged orientation to an engaged orientation is accomplished by causing the connector member to rotate from the disengaged orientation to the engaged orientation.

22. The method of claim 20, wherein the step of moving the connector member from a disengaged orientation to an engaged orientation is accomplished by manually pushing the frame assembly downward toward the support surface.

23. The method of claim 20, wherein the step of moving the connector member from a disengaged orientation to an engaged orientation is accomplished by manually pushing the connector member upward toward the first and second frame members.
